(19) United States
(12) Patent Application Publication
(10) Pub. No.: US 2014/0110527 A1
(43) Pub. Date: Apr. 24, 2014

(54) SELF-SUSTAINING DRONE AIRCRAFT FREIGHT AND OBSERVATION SYSTEM

(71) Applicant: Robert L. Sing, Santabarbara, CA (US)

(72) Inventor: Robert L. Sing, Santabarbara, CA (US)

(21) Appl. No.: 14/126,846

(22) PCT Filed: Jun. 17, 2011
(86) PCT No.: PCT/US11/40981

§ 371 Date: Dec. 16, 2013

(51) Int. Cl. B64D 9/00

(52) U.S. Cl. CPC B64D 9/00
USPC 244/118.1

(57) ABSTRACT

The self-sustaining drone aircraft freight and observation system (5) comprises a fleet of jet-powered drone aircraft (10) designed to carry freight (12) only. The drones (10) operate from a separate airfield in outlying areas to decrease land costs and to avoid disturbing residential and business areas. Navigation is automated using guidance from GPS satellites (16), and the aircraft (10) can be assisted by a hydraulic catapult (13) during takeoff to reduce the fuel payload. The observation component (18) includes sensors that can observe weather conditions and emergency signals from boats, ships and other sources. The system (5) may include a large-scale energy production center and multi-acre vegetable, herb and flower production center (26). The energy production center includes solar panels (30), fuel cells (38), and batteries (44). Thus, the system (5) does not need to be connected to the public utility electrical grid.

### TECHNICAL FIELD

The present invention relates generally to worldwide airborne freight transport and surveillance systems, and more specifically to a self-sustaining drone aircraft freight and observation system that also provides a fuel source and electrical power source.

### BACKGROUND ART

Freight delivery is a worldwide need. Humans or animals on board these systems require a narrow range of controlled temperatures and barometric pressures, not to mention food, drink, attendants, bathroom facilities, and the like. Passenger jets that carry passengers and animal cargo require very high insurance rates.

Moreover, on-board personnel required to run these passenger jets increase the operating costs of the carrier. The expense and insurance balloons when considering remote hub locations to service a population that is removed from familiar, established coastal and trade routes.

Typical manned air freight transportation systems and manned aerial observation systems are cost prohibitive in the aforementioned venues. Remote area airborne support operations often necessitate that the aircraft perform under extreme environmental conditions such as very short take-off and landing strips, restricted refueling capability, restricted ground support power facilities, and the like.

It would be desirable to have aircraft with the capability of delivering cargo from a specified remote hub that has self-sufficient servicing means. But then that limits the venues in which such a freight carrier and aerial observation system can operate. Such an airborne freight carrier should be able to transport up to a predetermined poundage of cargo and stay in the air for a predetermined amount of time, e.g., 20 hours. Remote field operations should be as autonomous as practicable. Command and control systems should be automated.

Notwithstanding the expansion of e-commerce, products must still be transported, and at some point in the product fulfillment phase, especially with respect to hard-to-reach locations, the products are likely to have been transported via airborne transport to the purchaser.

The much sought after ‘holy grail’ of airborne transport systems is to provide a system that substantially increases remote access in a cost effective manner. Notwithstanding current airborne transport and surveillance systems, there remains a need for an airborne transport and surveillance system that can serve remote population centers throughout the world.

Thus, a self-sustaining drone aircraft freight and observation system solving the aforementioned problems is desired.

### DISCLOSURE OF INVENTION

The self-sustaining drone aircraft freight and observation system includes a fleet of jet-powered drone aircraft that are designed to carry freight only. The drones operate from a separate airfield in outlying areas to decrease land costs and to avoid disturbing residential and business areas. Without humans or animals on board, there is no need for controlled temperatures, food, drink, attendants or bathroom facilities. Insurance rates are greatly reduced. Navigation is automated using guidance from OPS satellites, and the aircraft can be launched by a catapult, such as those used on aircraft carriers during takeoff to reduce the fuel payload.

The freight drone system component can profitably operate in parts of the world where populations are dense, but the financial levels of the population are not attractive for established air freight companies and their existing transport methodology. The availability of affordable air freight service can be a major opportunity for the populations in those areas.

For example, in China, where the population living close to the oceans has developed economically to a greater degree than those living in the inland areas, it would be economically advantageous to utilize the transportation component to service the sparsely populated inland areas. The same thing is true in areas of India, Africa, Asia, distant areas of Russia, more remote areas of North, Central, and South Americas, as well as New Zealand, Australia, and the like.

The transportation component of the system can be combined with an observation component, and with the combination of a large scale energy production center and multi-acre vegetable, herb and flower production center. The observation component allows the drone to observe and report on weather conditions, emergency signals from boats, ships or other sources where help is needed.

Electric power for the airport area may be supplied or supplemented by arrays of solar panels. The solar panels are on stilts and may form a roof of a greenhouse where plants can be grown. Electrical energy produced by the solar panels may be used to split water molecules into hydrogen and oxygen using an electrolysis plant. Water for the plants and hydrogen and oxygen production is supplied by wells. The hydrogen may further be used to produce electricity in fuel cells, while the oxygen can be stored in tanks and sold. Excess electricity is stored in batteries. The batteries can be trucked to a remote site for use of the electricity stored therein, and returned to the site of the system via access roads for recharging. Thus, the system does not need to be connected to the public utility electrical grid.

These and other features of the present invention will become readily apparent upon further review of the following specification and drawings.

### BRIEF DESCRIPTION OF THE DRAWINGS

FIG. 1 is an environmental, perspective view of a self-sustaining drone aircraft freight and observation system according to the present invention.

FIG. 2 is a perspective view showing a catapult runway for a self-sustaining drone aircraft freight and observation system according to the present invention.

FIG. 3 is a perspective view showing satellite command and control features of the drone aircraft freight and observation system according to the present invention.

FIG. 4 is a perspective view of an exemplary drone for a self-sustaining drone aircraft freight and observation system according to the present invention, showing the observation sensor.

FIG. 5 is a perspective view of an exemplary battery transport truck for a self-sustaining drone aircraft freight and observation system according to the present invention.

FIG. 6 is a perspective view showing a hydrogen plant for a self-sustaining drone aircraft freight and observation system.

FIG. 7 is a perspective view showing batteries of the energy production component of a self-sustaining drone aircraft freight and observation system.

FIG. 8 is a perspective view of exemplary solar panels on stilts for a self-sustaining drone aircraft freight and observation system.

FIG. 9 is a perspective view of an exemplary greenhouse for a self-sustaining drone aircraft freight and observation system.

FIG. 10 is a perspective view showing oxygen storage tanks for a self-sustaining drone aircraft freight and observation system.

FIG. 11 is a block diagram showing an exemplary fuel cell for a self-sustaining drone aircraft freight and observation system.

FIG. 12 is a block diagram showing the power source for a self-sustaining drone aircraft freight and observation system.

Similar reference characters denote corresponding features consistently throughout the attached drawings.

### BEST MODES FOR CARRYING OUT THE INVENTION

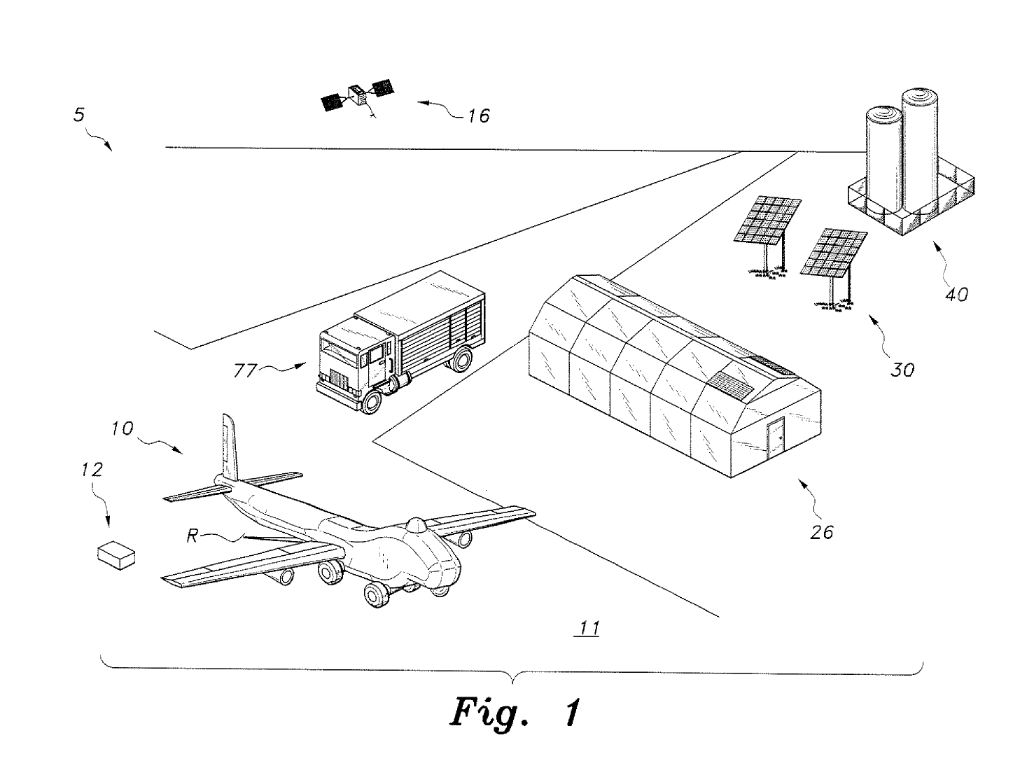

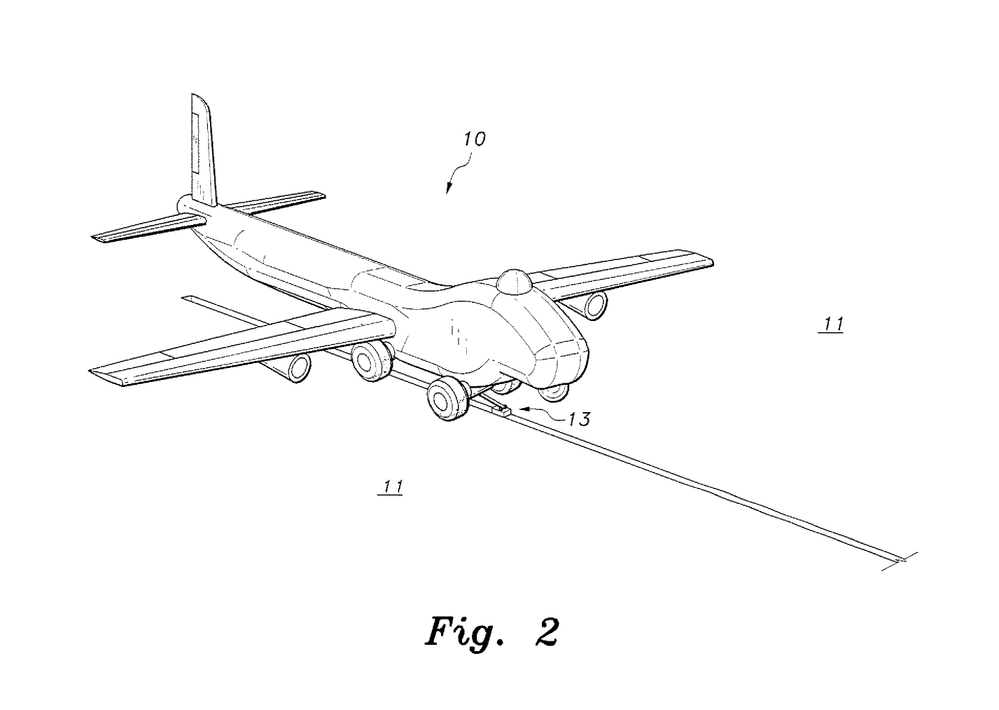

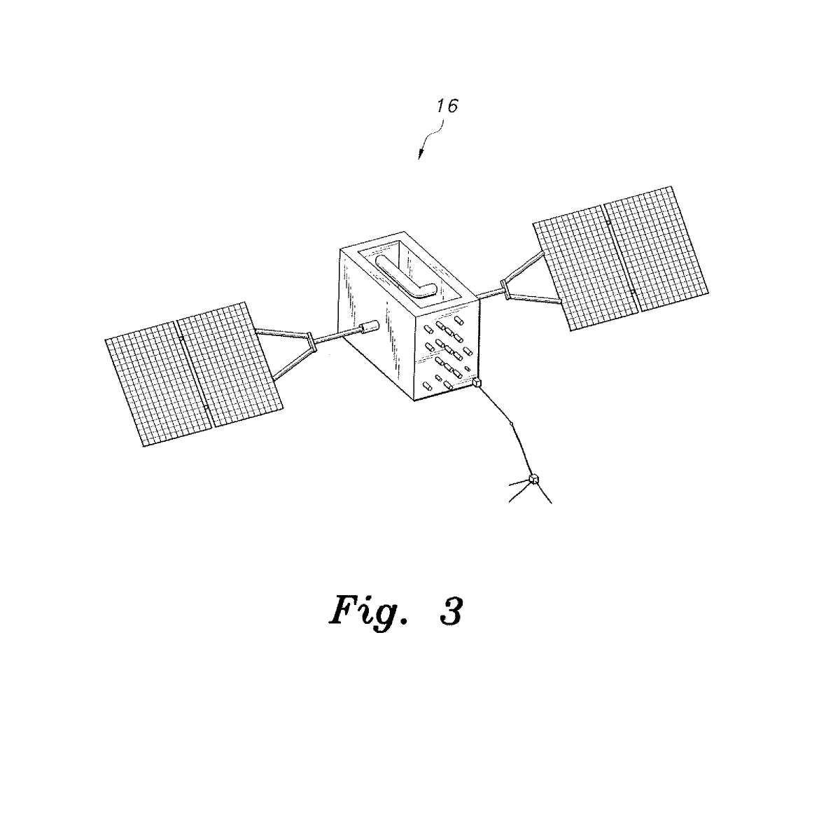

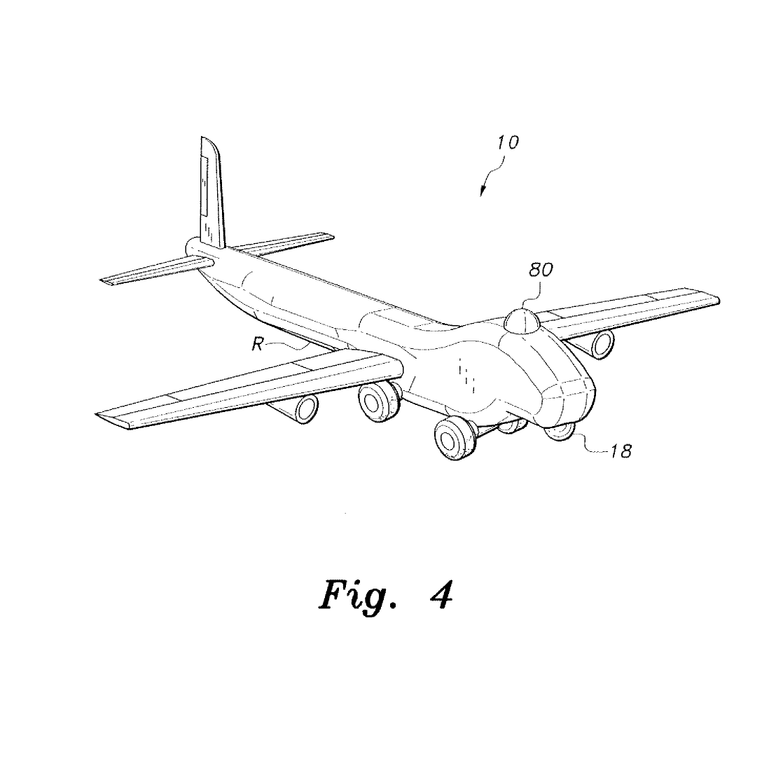

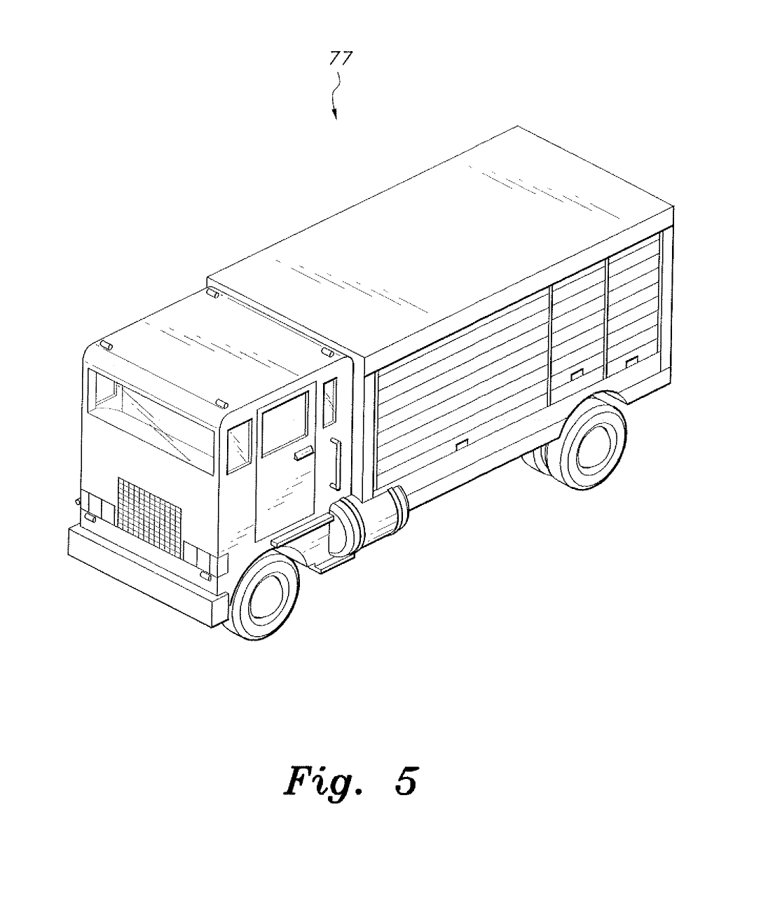

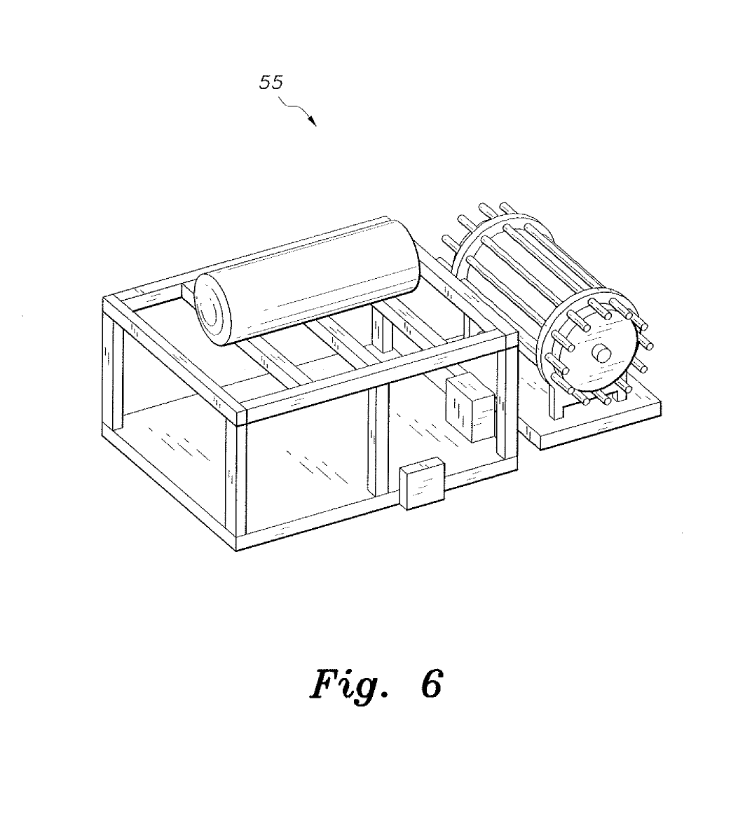

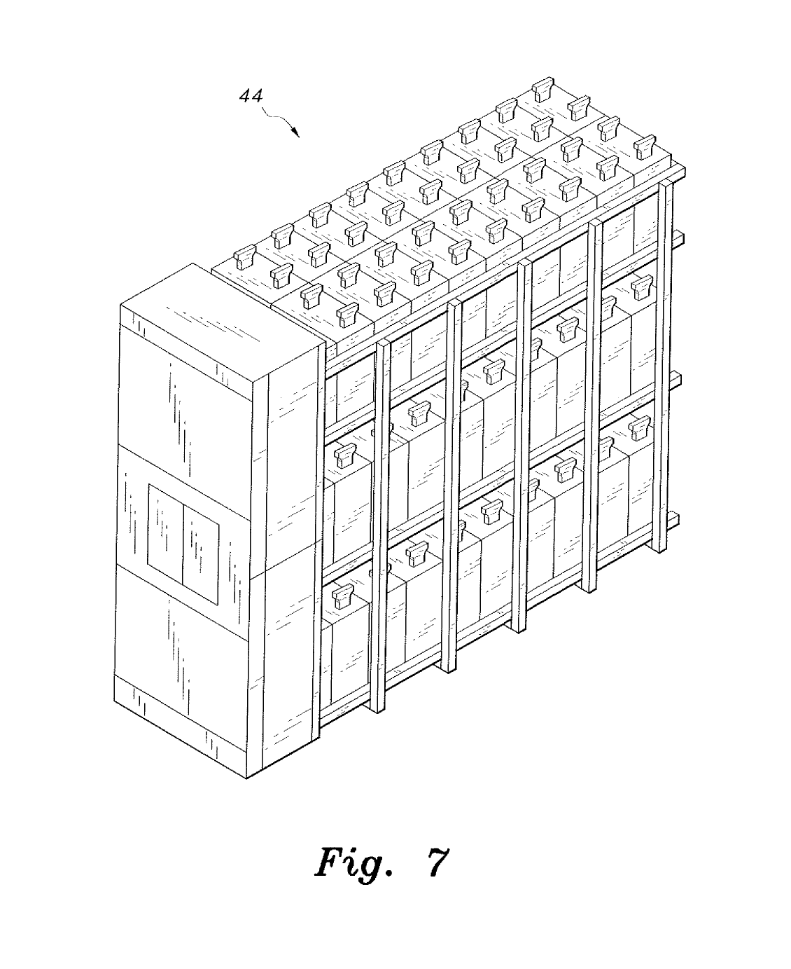

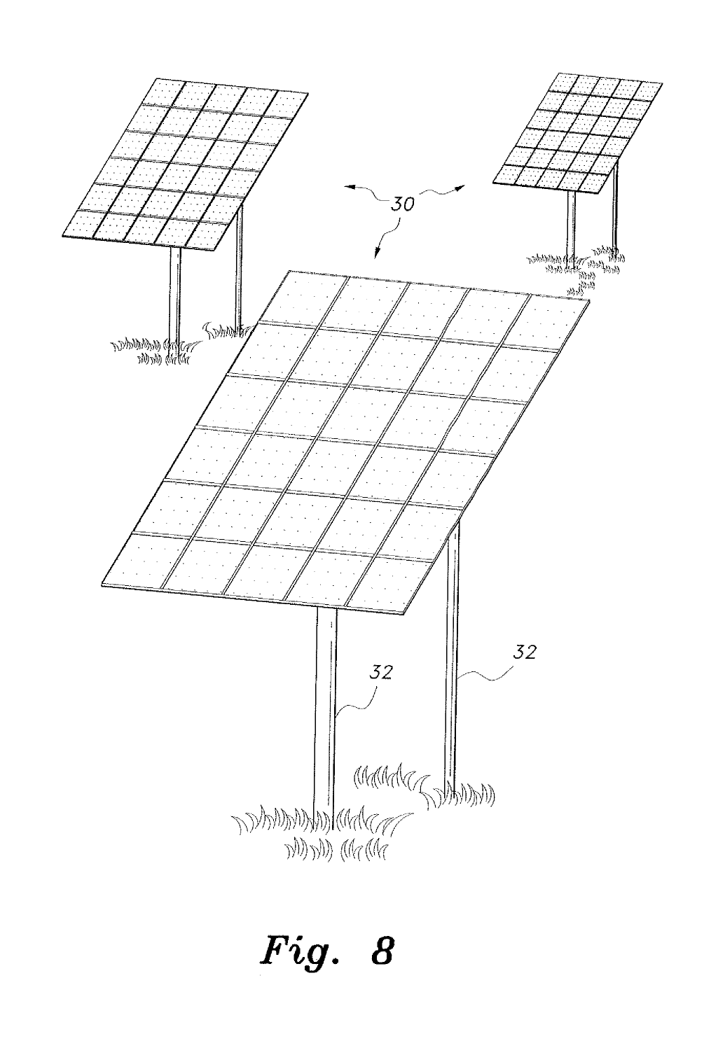

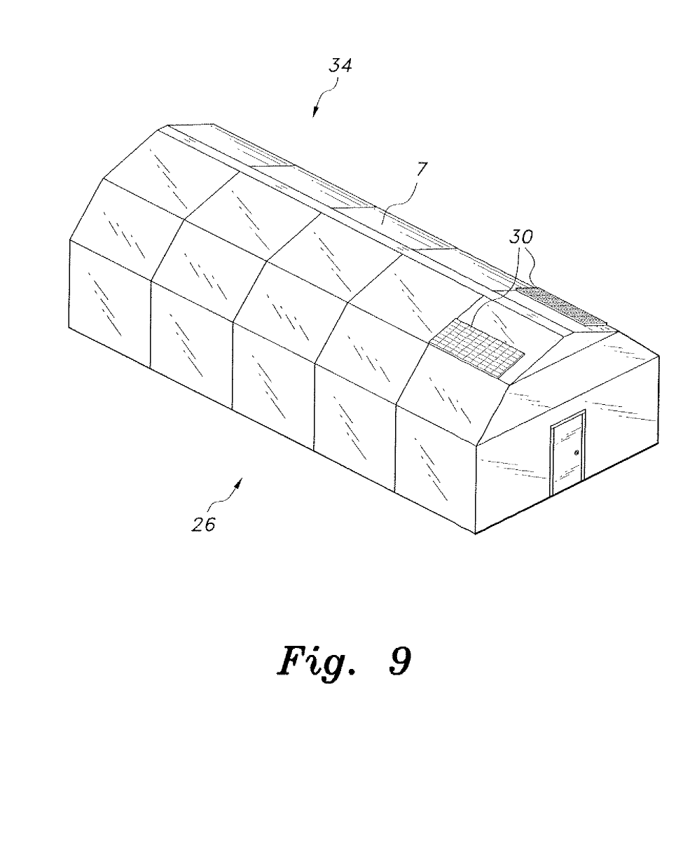

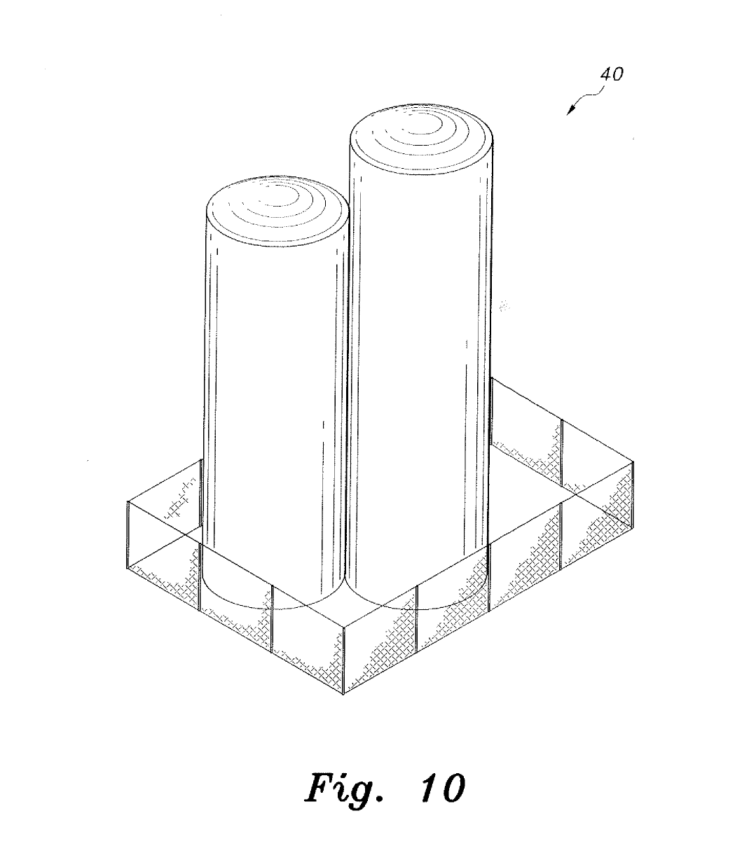

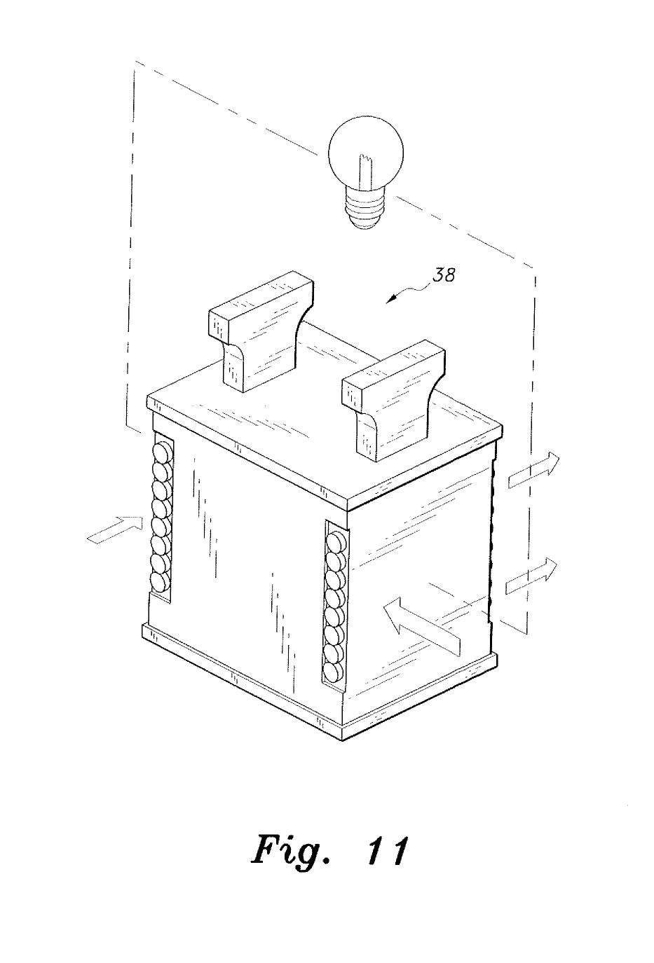

As shown in FIGS. 1-12, the self-sustaining drone aircraft freight and observation system (5) includes a fleet of jet-powered drone aircraft (10) that are designed to carry freight (12) only. Each drone (10) has fixed landing gear, no windows, and a ramp R for loading and unloading the freight (12). The drones (10) operate from separate airfields in outlying areas, to decrease land costs and to avoid disturbing residential and business areas. The drones (10) can take off and land using wide, paved runways (11). Without humans or animals on board, there is no need for controlled temperatures, food, drink, attendants or bathroom facilities. Insurance rates are greatly reduced.

Navigation is automated using guidance from GPS satellites (16) in communication with the navigation unit (80) of the aircraft (10). Where necessary, the aircraft (10) can be assisted during takeoff by the use of a hydraulic catapult (13) to reduce the fuel payload, or, alternatively, the craft (10) could be towed to approximately 45,000 feet and launched therefrom by a tow plane. The transportation component of the system (5) can be combined with an observation component (18) and a large-scale energy production center comprising solar panels (30), a hydrogen plant (55), fuel cells (38), oxygen storage tanks (40) and batteries (44) in conjunction with a multi-acre vegetable, fruit, herb and flower production center (26). The observation component (18) includes sensors that can observe weather conditions and emergency signals from boats, ships and other sources.

The solar panels (30) of the energy production center are preferably mounted on stilts (32). However, the solar panels (30) may also be disposed on the roof (7) of a greenhouse (34) of the multi-acre vegetable, herb and flower production center (26) where the plants and herbs are grown. Electrical energy produced by the solar panels (30) may be used to power a hydrogen generator (55) where water molecules are split into hydrogen and oxygen for use as a fuel supply. The hydrogen may further be used to produce electricity in fuel cells (38), while the oxygen can be stored in tanks (40) and sold.

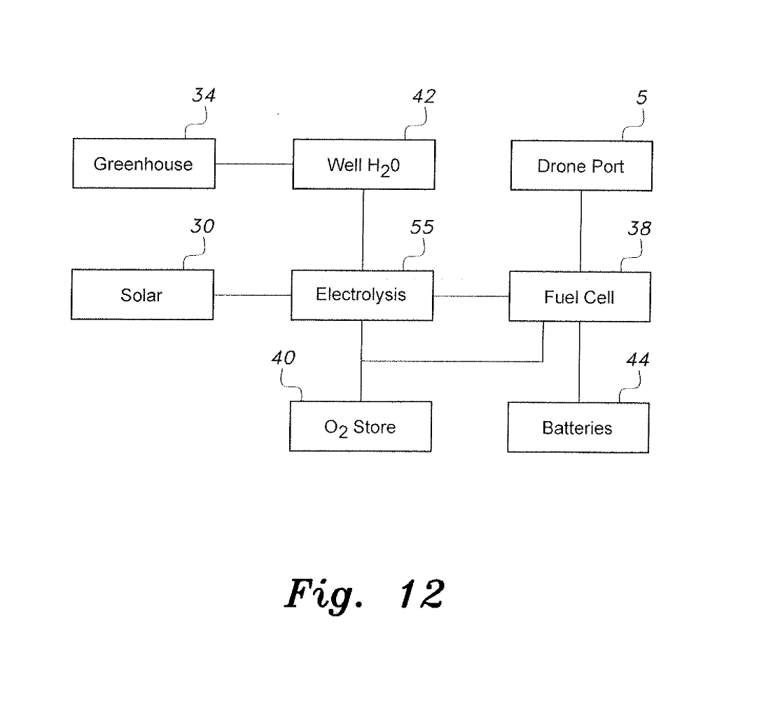

Water for the plants and hydrogen and oxygen production is supplied by wells (42), shown in the block diagram of FIG. 12. Excess electricity is stored in batteries (44). The batteries (44) can be trucked by battery carrier vehicles (77) to another site for use of the electricity stored therein, and returned using access roads to the site (5). Thus, the entire system (5) does not need to be connected to the public utility electrical grid.

It is to be understood that the present invention is not limited to the embodiment described above, but encompasses any and all embodiments within the scope of the following claims.

I claim:

1. A self-sustaining drone aircraft freight and observation system, comprising:
at least one drone aircraft having fixed landing gear, no windows, and a ramp for cargo carrying capability;
means for launching and retrieving the at least one drone aircraft in a remote area;
means for automatically navigating the at least one drone aircraft; and
means for producing energy required for launching, sustaining flight and retrieving the at least one drone aircraft.

2. The self-sustaining drone aircraft freight and observation system according to claim 1, further comprising means for observing weather conditions and emergency signals from boats, ships and other sources.

3. The self-sustaining drone aircraft freight and observation system according to claim 1, wherein said means for launching and retrieving said at least one drone aircraft in a remote area comprises means for assisting take-off of said drone aircraft, thereby reducing on-board fuel requirements of said at least one drone aircraft.

4. The self-sustaining drone aircraft freight and observation system according to claim 1, wherein said means for producing energy required for launching, sustaining flight, and retrieving said at least one drone aircraft further comprises means for distributing an excess of energy produced by said means for producing energy to locations remote from a site of the self-sustaining drone aircraft freight and observation system.

5. The self-sustaining drone aircraft freight and observation system according to claim 1, wherein said means for producing energy required for launching, sustaining flight and retrieving said at least one drone aircraft further comprises means for producing vegetables, fruits, herbs and flowers for distribution to locations remote from a site of the self-sustaining drone aircraft freight and observation system.

6. The self-sustaining drone aircraft freight and observation system according to claim 5, wherein said means for producing vegetables, fruits, herbs and flowers further comprises at least one water well providing water for growing the vegetables, fruits, herbs and flowers.
